(19) United States
(12) Patent Application Publication
(10) Pub. No.: US 2012/0222609 A1
(43) Pub. Date: Sep. 6, 2012

(54) WATERCRAFT ACCESSORY ATTACHMENT CLIP AND METHOD FOR MAKING AND USING SAME

(76) Inventor: Deborah Kutny Splaine, Northport, NY (US)

(21) Appl. No.: 13/411,199

(22) Filed: Mar. 2, 2012

Related U.S. Application Data
(60) Provisional application No. 61/448,652, filed on Mar. 2, 2011.

(51) Int. Cl. B63B 17/00; B23P 17/04; B29C 69/00

(52) U.S. Cl. 114/364; 114/343; 264/294; 29/428

(57) ABSTRACT

An accessory attachment clip for watercraft, attached to the watercraft without tools or hardware, and formed of a molded plastic or hard rubber first portion for fastening to the watercraft, and a second portion for attaching an accessory or accessory holder. The second portion is sized so as to be expanded when being positioned on the gunnels and to contract for an accurate fit. A set screw assists in securing the second portion. The accessory holder may be for a fishing rod or drinking cup. The clip may be attached to the gunnels by expanding the clip, sliding the clip over the gunnels, and releasing the clip. The set screw may be fastened to further secure the clip. The clip may be produced by forming within a mold, the plastic or hard rubber first portion, and the second portion. The set screw may be included in the molding process.

### CROSS-REFERENCE TO RELATED APPLICATIONS

This application claims priority from provisional patent application Ser. No. 61/448,652, filed on Mar. 2, 2011, which is incorporated herein in its entirety, for all purposes.

### BACKGROUND OF THE INVENTION

1. Field of the Invention

The present invention relates an article of manufacture which serves as an accessory attachment clip to secure holding accessories to a boat, kayak, canoe or human powered watercraft. In particular, it relates to an accessory attachment clip base that is ergonomically correct to the shape of the gunnels.

2. Background Art

A boat, kayak, canoe or human powered watercraft is designed to hold one to three or more persons within a cockpit of the watercraft. The top rim of the cockpit is referred to as the gunnels of the watercraft. The conventional method of attaching an accessory for use with a boat, kayak, canoe and human powered watercraft, is to drill holes in the watercraft and use additional hardware such as screws and bolts. These clips are permanent once in place, and to reposition them, they must be unscrewed and new holes must be drilled to move the clips to a new position. The holes in the watercraft cause permanent damage to the watercraft. Generally, the accessory that has been installed in this manner is for one purpose only, and the installation is not interchangeable for other accessories.

### SUMMARY OF THE INVENTION

The present invention overcomes at least in part some of the aforementioned disadvantages.

It is an object of the invention to provide an accessory clip that securely holds an accessory without causing damage to the watercraft.

It is a further object of the invention to provide an accessory attachment clip that is ergonomically correct to the shape of the gunnels and easily installed on the gunnels of the watercraft without the use of tools, additional hardware, drilling holes or damage to the watercraft.

It is an additional object of the invention to provide an accessory attachment clip that is compact in size.

It is yet another object of the invention to provide an accessory attachment clip that is easily repositioned to any aspect of the watercraft gunnels without tools, additional hardware or damage to the watercraft.

It is still another object of the invention to be able to use one or more accessory attachment clips anywhere on the gunnels of the watercraft depending on the users' desires.

It is yet a further object of the invention to be able to use one or more accessory attachment clips anywhere on the gunnels of the watercraft to attach different types of accessories.

It is still another object of the invention to provide a method for making such an accessory attachment clip.

In accordance with the first aspect of the present invention there is provided an accessory attachment clip for use with a boat, kayak, canoe or similar watercraft. The accessory attachment clip may be attached by the user or paddler (hereinafter the user, although the apparatus may also be installed by the manufacturer, distributor, seller or anyone servicing the watercraft) by sliding and clipping an accessory attachment clip over the gunnels of the watercraft into any position along the gunnels, as required by the user.

A molded in set screw is tightened by the user to further secure the accessory attachment clip to the watercraft. The user may use one or several clips along the boat gunnels depending on the boat and the accessories desired.

Furthermore, these accessory attachment clips are preferably fabricated from molded plastic or a hard rubber.

In accordance with the invention an accessory attachment clip can be comprised of one piece molded plastic. The accessory attachment clip can have two portions; one for clipping onto the gunnels of the watercraft and one with an indexing platform for attaching the accessory desired. The width of each manufactured clip can range from ½ inch to 3 inches depending on the model of the watercraft and the accessory being used. This is designed to securely hold the desired accessory while the person is fishing, drinking or otherwise engaged, while using a kayak, canoe or human powered watercraft.

The accessory attachment clip preferably is fabricated from molded plastic flexible enough to expand over the gunnels and accessory, yet securely hold the gunnels and accessory when contracted. The set screw is molded into the base to assist in securing the clip. This plastic and the set screw are inexpensive to manufacture.

Installing the accessory attachment clip to the watercraft is accomplished by slightly expanding the gunnels base or clip portion of the clip with the user's hands, sliding the clip over the gunnels of the watercraft and releasing the clip to secure the clip to the watercraft. Then the user tightens the set screw provided to further secure the clip to the watercraft. This installation is accomplished without the use of any tools, additional hardware or damage to the watercraft.

The accessory attachment clip further has an indexing platform molded onto the upper region to hold the desired accessory and to enable adjusting the angle of the attached accessory for optimal use. The user just aligns the desired accessory onto this indexing platform and secures the accessory at the desired angle with an additional set screw, generally provided with the accessory. Thus, the top portion of the accessory attachment clip will enable the user to attach an accessory or an accessory holder (for example: a fishing rod holder or a camera holder) and be able to interchange the accessory with another (for example: a drinking cup holder, a storage container holder, or a sail, etc.).

### BRIEF DESCRIPTION OF THE DRAWINGS

The foregoing aspects and other features of the present invention are explained in the following description, taken in connection with the accompanying drawings, wherein:

FIG. 1 is a top, perspective view showing the article of manufacture in accordance with the invention in place, for use, on the gunnels of the watercraft.

FIG. 2 is a cross sectional view of the embodiment of the invention in the closed position.

FIG. 3 is a cross section view of the embodiment of the invention in the expanded position.

FIG. 4 is a cross-sectional side view showing a fishing rod holder in place for use at a typical angle.

### DETAILED DESCRIPTION OF THE PREFERRED EMBODIMENT

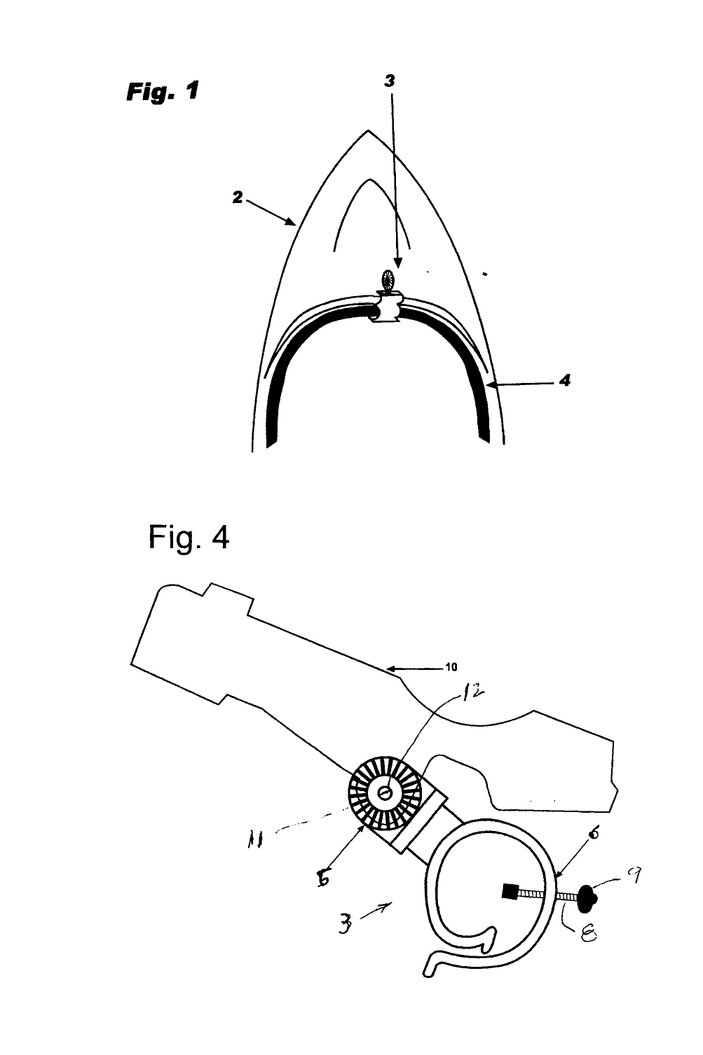

FIG. 1 is top perspective view of a kayak or similar watercraft 2 or a canoe, a row boat, or similar watercraft incorporating features of the present invention. Accessory attachment clip 3 is shown installed, in place on the gunnels 4 of watercraft 2. The accessory attachment clip 3 can be clipped on by a person who is onboard; for example in the watercraft 2, or just outside, in a position to service watercraft 2.

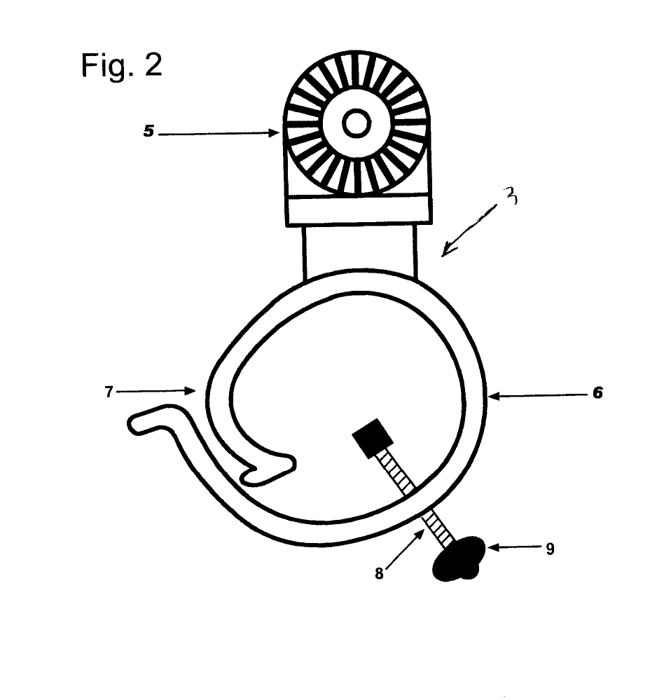

FIG. 2 is a cross sectional view of a clip in accordance with the invention in the closed position, showing the top portion 5 of the accessory attachment clip 3 where the accessory (for example: fishing rod holder) is attached. The lower portion 6 of the accessory attachment clip will expand over the watercraft gunnels, but in the closed position has an opening 7 of, for example, 0.125 inches. The set screw adjustment 8 is located in the lower portion 6 of the attachment clip 3 and has a knob 9 to further tighten the accessory attachment clip to the watercraft 2.

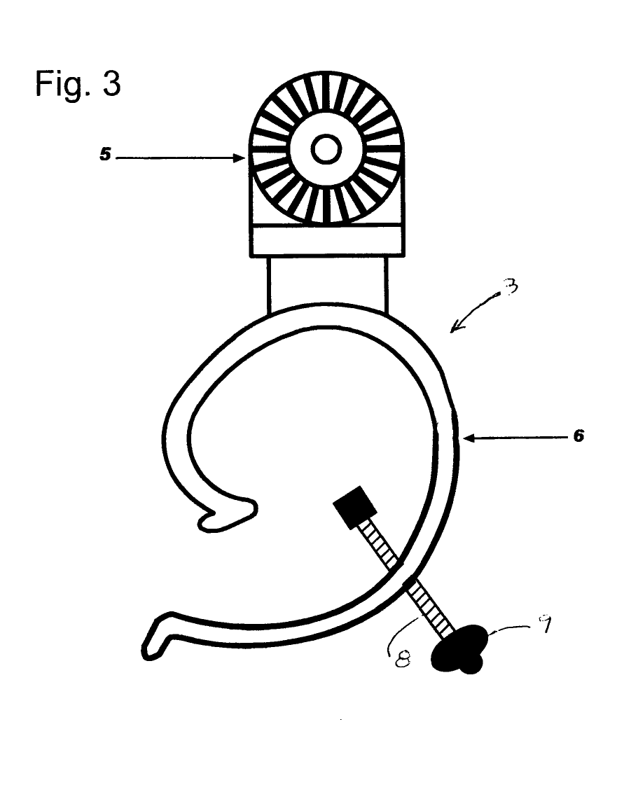

FIG. 3 is a cross sectional view of the clip 3 of the invention in the open position. Showing the top portion of the accessory attachment clip 3, where the accessory is attached. The lower portion 6 of the accessory attachment clip 3 is shown as expanded to slide over the watercraft gunnels in the open position, in which it may have having an opening of, for example, up to 2 inches.

In FIG. 4, an accessory, such as by way of example, a fishing rod holder 10 is secured to the upper portion 5 of clip 3, in a position define by mating of radial ribs (not shown) with the grooves 11 in top portion 5 of clip 3, wherein the grooves 11 form an indexing platform. A fastener such as a screw 12 or a wing nut (not shown) may be used to secure the accessory at one of the discrete angular positions with respect to the top portion 5 of clip 3 defined by the mating of the ribs (not shown) and grooves 11.

Although the present invention is described with reference to the embodiments shown in the drawings, it should be understood that the present invention can be embodied in many alternate forms of embodiments. In addition, any suitable size, shape or type of elements or materials could be used. In addition, although the accessory attachment clip of the present invention is shown on the gunnels of a kayak, canoe or watercraft, it will be understood that they may be used on many kinds of other edges where shafts or pipes, or holders for them, or holders for any other accessories, are to be attached. No tools or additional hardware are needed to attach the accessory attachment clip to the gunnels of a boat, kayaks, canoe or human powered watercraft. The clip is small, compact, movable to any position on the gunnels and removable quickly without any tools, and without any damage to the watercraft.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An accessory attachment clip for watercraft, comprising:
a molded plastic or hard rubber first portion for fastening to the watercraft; and
a second portion for attaching an accessory or accessory holder.

2. The accessory attachment clip of claim 1, wherein the second portion is sized so as to be expanded when being positioned on the gunnels of the watercraft and to contract for an accurate fit to the gunnels.

3. The accessory attachment clip of claim 2, further comprising a set screw for assisting in securing the second portion to the watercraft.

4. The accessory attachment clip of claim 1, wherein the second portion has an opening, and the molded plastic or hard rubber is sufficiently flexible so as to allow the opening to be enlarged so that the second portion can be positioned on the gunnels and to contract for an accurate fit to the gunnels.

5. The accessory attachment clip of claim 4, wherein the opening is approximately 0.125 inches in a contracted configuration, and 2 inches in an expanded configuration.

6. The accessory attachment clip of claim 4, further comprising a set screw for assisting in securing the second portion to the watercraft.

7. The accessory attachment clip of claim 1, configured to be connected to the watercraft without tools or hardware.

8. The accessory attachment clip of claim 1, in combination with an accessory holder for attachment to a portion of the clip.

9. The accessory attachment clip of claim 8, wherein the accessory holder is configured for holding one of a fishing rod, a drinking cup, a storage container, a camera or a sail.

10. The accessory attachment clip of claim 9, further in combination with one of a fishing rod, a drinking cup, a storage container, a camera or a sail, secured to said accessory holder.

11. A method for attaching the accessory clip of claim 1 to the water craft, comprising:
expanding the clip;
sliding the clip over the gunnels of the watercraft; and
releasing the clip to secure the clip to the watercraft.

12. The method of claim 11, wherein the clip has a set screw, further comprising:
tightening the set screw to further secure the clip to the watercraft.

13. The method of claim 11, performed without the use of tools and without damage to the watercraft.

14. A method for forming an accessory attachment clip for watercraft, comprising:
forming within a mold, a plastic or hard rubber first portion for fastening to the watercraft; and
forming a second portion for attaching an accessory holder.

15. The method of claim 14, further comprising molding a set screw into the mold.

16. The method of claim 14, further comprising molding an indexing platform into the first portion.

17. The method of claim 14, further comprising attaching an accessory to the accessory holder.

18. The method of claim 14, further comprising attaching the accessory clip to the water craft, by steps comprising:
expanding the clip;
sliding the clip over the gunnels of the watercraft; and
releasing the clip to secure the clip to the watercraft.

19. The method of claim 18, wherein the clip has a set screw, further comprising:
tightening the set screw to further secure the clip to the watercraft.
